(19) United States
(12) Patent Application Publication
(10) Pub. No.: US 2026/0077574 A1
(43) Pub. Date: Mar. 19, 2026

(54) Printable decal film having flashing points

(71) Applicant: QUAD FILM LTD, LAS VEGAS, NV (US)

(72) Inventor: Ni KE, LAS VEGAS, NV (US)

(73) Assignee: QUAD FILM LTD, LAS VEGAS, NV (US)

(21) Appl. No.: 19/034,401

(22) Filed: Jan. 22, 2025

(30) Foreign Application Priority Data
Sep. 14, 2024 (CN) 2024222532404

(51) Int. Cl. B32B 27/08; B32B 7/06; B32B 7/12; B32B 27/30; B32B 27/36; B32B 27/40

(52) U.S. Cl. CPC B32B 27/08; B32B 7/06; B32B 7/12; B32B 27/304; B32B 27/36; B32B 27/40; B32B 2255/10; B32B 2255/26; B32B 2274/00; B32B 2307/4023; B32B 2307/7376; B32B 2307/748

(57) ABSTRACT

The present invention provides a printable decal film having flashing points, wherein the printable decal film having flashing points comprises sequentially laminated protective layer, coating layer, first substrate layer, first installation adhesive layer, printing layer, second substrate layer, second installation adhesive layer and release film layer; the protective layer is provided on the coating layer, the first substrate layer is provided underneath the coating layer, the first installation adhesive layer is provided underneath the first substrate layer, the printing layer is provided underneath the first installation adhesive layer, the second substrate layer is provided underneath the printing layer, the second installation adhesive layer is provided underneath the second substrate layer, and the release film layer is provided underneath the second installation adhesive layer.

### INCORPORATION BY REFERENCE

This application claims the benefit of priority from China Patent Application No. 2024222532404 filed on Sep. 14, 2024, the contents of which are hereby incorporated by reference in their entirety.

### TECHNICAL FIELD

The present invention relates to the technical field of printable decal films, specifically a printable decal film for applying over a surface of an automobile with flashing points.

### BACKGROUND TECHNOLOGY

With the increase of personalized requirements on automobiles, coloring and printing on the automobiles is popular, the printable decal film for automobiles commercially available is a prime choice, however, common printable decal films possess unified colors and anti-aging and anti-corrosion performance thereof is poor, which cannot satisfy the personalized requirements of users and the printed patterns are liable to deteriorate. Therefore, we propose a printable decal film having flashing points to address the foregoing problems.

### SUMMARY OF THE INVENTION

In view of the deficiency of the prior art, the present invention provides a printable decal film having flashing points. A layer of anti-corrosion anti-aging TPU protective film is coated over the printable decal film having flashing points, and glitter powders are used to have the colored layers to be glittering.

The present invention provides a printable decal film having flashing points, wherein the printable decal film having flashing points comprises a protective layer, a coating, a first substrate layer, a first installation adhesive layer, a printing layer, a second substrate layer, a second installation adhesive layer, and a release film layer which are sequentially laminated; specifically, the protective layer is provided on the coating layer, the first substrate layer is provided underneath the coating layer, the first installation adhesive layer is provided underneath the first substrate layer, the printing layer is provided underneath the first installation adhesive layer, the second substrate layer is provided underneath the printing layer, the second installation adhesive layer is provided underneath the second substrate layer, and the release film layer is provided underneath the second installation adhesive layer.

The protective layer having a thickness of 2^{˜}188 μm; preferably 20^{˜}125 μm, further preferably the thickness is 16^{˜}75 μm; the protective layer is made from any of polyethylene terephthalate (PET), polyethylene (PE), oriented polypropylene (OPP) (transparent or semi-transparent or colored polyester films) and the protective layer protects the coating layer thereunder.

Wherein the coating layer having a thickness of 2^{˜}30 μm, preferably 2^{˜}20 μm, and further preferably 5^{˜}10 μm; the coating layer is made from ethylene vinylacetate (EVA); the coating layer has ultraviolet additives, so that the coating layer has ultraviolet proof and aging resistant properties; and the coating layer has scratch self-repair, scratch resistance, corrosion resistance and pollution resistance functions. Wherein the first substrate layer having a thickness of 20 ^{˜} 500 μm, preferably 75^{˜}300 μm, further preferably 100^{˜}150 μm, and the first substrate layer is made from thermoplastic polyurethane elastomer (TPU), polyvinyl chloride (PVC), thermoplastic polyurethane (TPH), PET or polypropylene (PP); TPU is a kind of thermoplastic elastomer, which is a polymer material obtained by polymerization reaction of methylene diphenyl diisocyanate (MDI) or toluene diisocyanate (TDI) and giant-molecule polyols and polyols of low molecular weights (as chain extenders); the TPU materials have a wide range of hardness, are abrasion resistant, grease resistant and elastic, and are widely used in fields of daily commodities, sporting goods, dolls and decorative materials; and the TPU materials comprise primarily polyether-ether-ketone, polyesters and isocyanate. The PVC material is made by polymerization of vinyl chloride monomers and is a kind of common thermoplastic. The TPH material is a kind of thermoplastic, and a kind of elastomer material of high strength, high water tolerance and high abrasion resistance; can bear extreme temperature, pressure and chemical erosion, and maintain good physical performance. The PET film is also called a high temperature resistance polyester film, has excellent physical performance, chemical properties, dimension stability, transparency, and recyclability; possesses excellent mechanical properties, and a strength thereof is the highest among all the thermoplastics, tensile strength and shock strength thereof is higher than common films, extension thereof is good, size thereof is stable, and the PET film also has good thermostabilization, cold resistance, chemical agent resistance and grease resistance. The PP film comprises cast polypropylene and biaxially oriented polypropylene, and the cast polypropylene comprises isotactic polypropylene produced by extrusion blow molding and cast polypropylene (CPP) produced by T molding; the BOPP is a novel film developed to replace glass paper, and is characterized in having high mechanical strength, good ductility, transparency and lustrousness. Preferably, the substrate layers are selected from thermoplastic elastomer TPU or TPH, and more preferably, the substrate layers are made from TPU.

The first installation adhesive layer (also called a pressure sensitive adhesive layer) having a thickness of 5^{˜}100 μm, preferably 25^{˜}75 μm; further preferably 30^{˜}35 μm; and the pressure sensitive adhesive can be classified into a rubber type and a resin type according to the resin components. The rubber type can be divided into natural rubber and synthetic rubber; while the resin type comprises primarily acrylics, organosilicone and polyurethanes. The rubber type pressure sensitive adhesive layer comprises primarily rubber, together with auxiliary elements, such as tackifying resin, plasticizers, filling materials, viscosity adjusting agents, vulcanizing agents, antiaging agents, and solvents. And the resin type pressure sensitive adhesive layer comprises primarily resin, together with auxiliaries such as defoaming agents, flattening agents, anti-aging agents, and wetting agents. Glitter powder is added in the first installation adhesive layer, so that the first installation adhesive layer is glittering.

The printing layer having a thickness of 0.1^{˜}20 μm, preferably 0.5^{˜}1.7 μm, further preferably 1^{˜}1.2 μm, and the printing layer is printed by an inkjet printer using inkjet printing ink to form colored layers or patterned layers.

The second substrate layer having a thickness of 2^{˜}188 μm, preferably 25^{˜}100 μm, further preferably 50^{˜}75 μm, and the second substrate layer is made from TPU, TPH, PET or PVC, and performance of the second substrate layer is the same as the performance of the first substrate layer; and preferably the second substrate layer is made from PVC. Wherein the second installation adhesive layer (also called a pressure sensitive adhesive layer) having a thickness of 20^{˜}188 μm, preferably 25^{˜}70 μm; further preferably 30^{˜}50 μm, and the second installation adhesive layer is made from an acrylate pressure sensitive adhesive layer, and a performance thereof is the same as the performance of the first installation adhesive layer.

Wherein the release film layer having a thickness of 12^{˜}188 μm, preferably 50^{˜}170 μm, further preferably 130^{˜}150 μm; the release film layer comprises any of PET, PE, oriented polypropylene (OPP) (transparent or semi-transparent or colored polypropylene films). The release film layer is to apply a silica gel releasing agent over a surface of the PET, PE, OPP films, so to exhibit a light while stable release force relative to different organic pressure sensitive adhesives. Different organic pressure sensitive adhesives, for example, holt-melting adhesives, acrylic adhesives and pressure sensitive rubber falling into a rubber system, require different release films and release forces, in view of the viscosity of the adhesives to be released the release forces are to be adjusted, so as to have very light while stable release force. The release film layer comprises preferably a PET embossed release film, and patterns on the PET embossed release film comprise uniform grids, so that, a grid pattern can be formed on a surface of the second installation adhesive layer, and the grid pattern can be used to disseminate air inside, and the printing layer can be dry applied properly.

A preparation method of the printable decal film having flashing points comprises the following steps:
(1) First of all, producing a transparent TPU film as a first substrate layer by casting;
(2) Coating an acrylate pressure sensitive adhesive layer containing glittering powder at a side of the first substrate layer by spirally wound coating and attaching, and forming the first installation adhesive layer, during which, extending using a tension of 250^{˜}300 N, no deformation is allowed, thereafter, coating an acrylate pressure sensitive adhesive layer containing glittering powder on a surface of the first substrate layer, coating by roller coating and drying in drying ovens, all the drying ovens are 4 m in length, totally seven drying ovens are used, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min;
(3) After drying, taking out from the drying oven, covering a release film layer by mirror roll attaching over a side of the first installation adhesive layer, and making the TPU semi-product film with flashing points; and the release film layer comprises a PET release film;
(4) Coating a coating layer in another side of the first substrate layer, coating and drying in the drying ovens, all the drying ovens are 4 m in length, totally seven drying ovens are used, with a total length of 28 m, temperature in the seven drying ovens are respectively: 60° C. in a first drying oven, 70° C. in a second drying oven, 80° C. in a third drying oven, 90° C. in a fourth drying oven, 110° C. in a fifth drying oven, 120° C. in a sixth drying oven, 90° C. in a seventh drying oven, and drying time is 7 m/min, after drying, taking out from the drying ovens and the coating layer is formed;
(5) After drying, taking out from the drying ovens, coating a protective layer by mirror roll attaching over a side of the coating layer, and the protective layer comprises PET, PE or OPP films;
(6) Making a white PVC film by casting as the second substrate layer;
(7) Coating the acrylate pressure sensitive adhesive layer containing glittering powder at a side of the second substrate layer and forming the second installation adhesive layer, during which, extending using a tension of 250^{˜}300 N, no deformation is allowed, thereafter, coating an acrylate pressure sensitive adhesive layer containing glittering powder on a surface of thesecond substrate layer, coating by roller coating and drying in drying oven, all the drying ovens are 4 m in length, totally seven drying ovens are used, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min;
(8) After drying, taking out from the drying ovens, coating the release film layer, the release film layer comprises a PET embossed release film, and after coating the second installation adhesive layer has patterns thereon;
(9) Printing a layer of pattern or a color on another side of the second substrate layer by using an inkjet printer, drying, and forming a printing layer; and making the semi-finished printing layer;
(10) Releasing the release film layer on the first installation adhesive layer underneath the TPU semi-finished film with flashing points via a coating machine; and
(11) Attaching a TPU semi-finished film with flashing points and the semi-finished printing layer together by mirror roll hot attaching, coating the first installation adhesive layer of the TPU semi-finished film with flashing points over the printing layer of the semi-finished printing layer, and making the printing decal film having flashing points.

Beneficial effects of the present invention are: the present invention provides a printable decal film having flashing points for altering color and decals on a surface of an automobile, so that the colors and patterns on the surface of the automobile can have glittering effects, and is corrosion and aging resistant.

### BRIEF DESCRIPTION OF DRAWINGS

FIG. 1 is a schematic diagram showing a section view of a printable decal film with flashing points in an embodiment of the present invention.

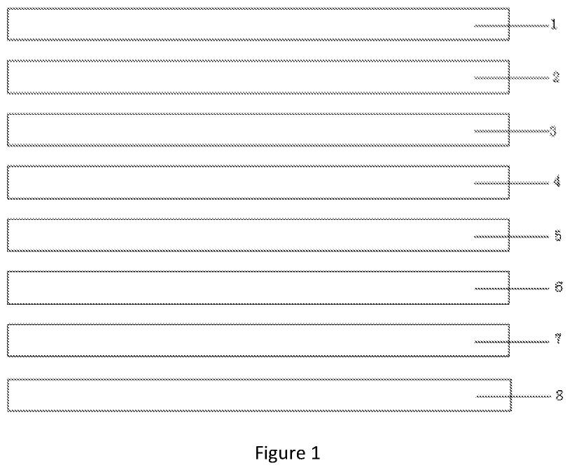

Reference numbers in the drawings are:

| | | | |
|---|---|---|---|
| Protective layer | 1 | Coating layer | 2 |
| First substrate layer | 3 | First installation adhesive | 4 |
| | | layer | |
| Printing layer | 5 | Second substrate layer | 6 |
| Second installation adhesive | 7 | Release film layer | 8 |
| layer | | | |

### EMBODIMENTS

In order to help understand the technical features, purposes and effects of the present invention, hereinafter the embodiments of the present invention will be further described with reference to the drawings. Hereinafter a detailed description of the preparation steps of the printable decal film with flashing points according to the present invention:
(1) First of all, making a transparent TPU film to be the first substrate layer 3 by casting;
(2) Coating an acrylate pressure sensitive adhesive layer containing glittering powder at a side of the first substrate layer 3 by spirally wound coating and attaching, and forming the first installation adhesive layer 4, during which, extending using a tension of 250^{˜}300 N, no deformation is allowed, thereafter, coating an acrylate pressure sensitive adhesive layer containing glittering powder on a surface of the first substrate layer 3, coating by roller coating and drying in drying ovens, all the drying ovens are 4 m in length, totally seven drying ovens are used, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min; wherein, the amount of the glittering powder accounts for 0.1^{˜}3% of a mass of the acrylate pressure sensitive adhesive layer, preferably, the amount is 0.5^{˜}1.3%; when too much glittering powder is used, the adhesive may not work, when little glittering powder is used, the glittering effects may be weak; in the present invention, by adding the glittering powder in the stipulated amount, the adhesive maintains good adhesion while good glittering effects are achieved, which is favorable. Before adding the glittering powder into the acrylate pressure sensitive adhesive layer a filter is used for filtering and screening, and filter elements of the filter have a filter range of 20^{˜}1000 μm; with the filter elements of this specification, the glittering powder of good quality can be preserved while foreign matters can be removed, the quality of the glittering powder can be guaranteed, viscosity of the adhesive layer can be promised, and the glittering effects of the adhesive layer can be improved. During coating, a plate used for coating has a thickness of 50^{˜}750 μm, preferably 250^{˜}500 μm; with the plate of such thickness during coating, no undesired coating mark will appear, coating will be full and uniform, and the coating effects are good.
(3) After drying, taking out from the drying oven, covering a release film layer over a side of the first installation adhesive layer, and making the TPU semi-product film with flashing points; and the release film layer comprises a PET release film;
(4) Coating a coating layer 2 in another side of the first substrate layer 3, coating and drying in the drying ovens, all the drying ovens are 4 m in length, totally seven drying ovens are used, with a total length of 28 m, temperature in the seven drying ovens are respectively: 60° C. in a first drying oven, 70° C. in a second drying oven, 80° C. in a third drying oven, 90° C. in a fourth drying oven, 110° C. in a fifth drying oven, 120° C. in a sixth drying oven, 90° C. in a seventh drying oven, and drying time is 7 m/min, after drying, taking out from the drying ovens and the coating layer 2 is formed; the coating layer 2 is made from ethylene vinylacetate containing UV agents, wherein the amount of the UV agents accounts for 1%^{˜}10% of a mass or weight of the ethylene vinylacetate, preferably 2%^{˜}5%;
(5) After drying, taking out from the drying ovens, coating a protective layer 1 over a side of the coating layer 2, and the protective layer 1 comprises PET, PE or OPP films;
(6) Making a white PVC film by casting as the second substrate layer 6;
(7) Coating the acrylate pressure sensitive adhesive layer containing glittering powder at a side of the second substrate layer 6 and forming the second installation adhesive layer 7, during which, extending using a tension of 250^{˜}300 N, no deformation is allowed, thereafter, coating an acrylate pressure sensitive adhesive layer containing glittering powder on a surface of the second substrate layer 6, coating by roller coating and drying in drying oven, all the drying ovens are 4 m in length, totally seven drying ovens are used, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min;
(8) After drying, taking out from the drying ovens, coating the release film layer 8, the release film layer 8 comprises a PET embossed release film, and after coating the second installation adhesive layer 7 has patterns thereon;
(9) Printing a layer of pattern or a color on another side of the second substrate layer 6 by using an inkjet printer, drying, and forming a printing layer 5; and making the semi-finished printing layer;
(10) Releasing the release film layer on the first installation adhesive layer 4 underneath the TPU semi-finished film with flashing points via a coating machine; and
(11) Attaching a TPU semi-finished film with flashing points and the semi-finished printing layer 5, coating the first installation adhesive layer 4 of the TPU semi-finished film with flashing points over the printing layer of the semi-finished printing layer, and making the printing decal film with flashing points.

Using the preparation steps as stipulated in the foregoing paragraphs, products with different film thicknesses are made in the present invention by adjusting the coating speeds of the films, and specifications of the printing or coating machines, which are shown in the following embodiments.

### Embodiment 1

In the present embodiment, the printable decal film with flashing points comprises sequentially stacked layers as following:
(1) A protective layer, of PET, and a thickness of 38 μm;
(2) A coating layer, of ethylene vinylacetate containing UV agents, and a thickness of 6 μm;
(3) A first substrate layer, of TPU and a thickness of 100 μm;
(4) A first installation adhesive layer, of acrylate pressure sensitive adhesives mixed with glittering powder and a thickness and 100 μm;
(5) A printing layer, of printable inkjet oil and a thickness of 0.5 μm;
(6) A second substrate layer, of PVC and a thickness of 55 μm;
(7) A second installation adhesive layer, of acrylate pressure sensitive adhesives and a thickness of 35 μm;
(8) A release film layer, of PET and a thickness of 140 μm.

### Embodiment 2

In the present embodiment, the printable decal film with flashing points comprises sequentially stacked layer as following:
(1) A protective layer, of PET and a thickness of 40 μm;
(2) A coating layer, of ethylene vinylacetate containing UV agents and a thickness of 10 μm;
(3) A first substrate layer, of TPU and a thickness of 150 μm;
(4) A first installation adhesive layer, of acrylate pressure sensitive adhesives mixed with glittering powder and a thickness of 40 μm;
(5) A printing layer, of printable inkjet oil and a thickness of 0.7 μm;
(6) A second substrate layer, of PVC and a thickness of 60 μm;
(7) A second installation adhesive layer, of acrylate pressure sensitive adhesives and a thickness of 50 μm;
(8) A release film layer, of PET and a thickness of 150 μm.

### Embodiment 3

In the present embodiment, the printable decal film with flashing points comprises sequentially stacked layer as following:
(1) A protective layer, of PET and a thickness of 75 μm;
(2) A coating layer, of ethylene vinylacetate containing UV agents and a thickness of 13 μm;
(3) A first substrate layer, of TPU and a thickness of 175 μm;
(4) A first installation adhesive layer, of acrylate pressure sensitive adhesives mixed with glittering powder and a thickness of 55 μm;
(5) A printing layer, of printable inkjet oil and a thickness of 0.9 μm;
(6) A second substrate layer, of PVC and a thickness of 55 μm;
(7) A second installation adhesive layer, of acrylate pressure sensitive adhesives and a thickness of 52 μm;
(8) A release film layer, of PET and a thickness of 173 μm.

### Embodiment 4

In the present embodiment, the printable decal film with flashing points comprises sequentially stacked layer as following:
(1) A protective layer, of PET and a thickness of 160 μm;
(2) A coating layer, of ethylene vinylacetate containing UV agents and a thickness of 15 μm;
(3) A first substrate layer, of TPU and a thickness of 200 μm;
(4) A first installation adhesive layer, of acrylate pressure sensitive adhesives mixed with glittering powder and a thickness of 65 μm;
(5) A printing layer, of printable inkjet oil and a thickness of 1.5 μm;
(6) A second substrate layer, of PVC and a thickness of 76 μm;
(7) A second installation adhesive layer, of acrylate pressure sensitive adhesives and a thickness of 68 μm;
(8) A release film layer, of PET and a thickness of 178 μm.

### Embodiment 5

In the present embodiment, the printable decal film with flashing points comprises sequentially stacked layer as following:
(9) A protective layer, of PET and a thickness of 188 μm;
(10) A coating layer, of ethylene vinylacetate containing UV agents and a thickness of 30 μm;
(11) A first substrate layer, of TPU and a thickness of 255 μm;
(12) A first installation adhesive layer, of acrylate pressure sensitive adhesives mixed with glittering powder and a thickness of 75 μm;
(13) A printing layer, of printable inkjet oil and a thickness of 2 μm;
(14) A second substrate layer, of PVC and a thickness of 120 μm;
(15) A second installation adhesive layer, of acrylate pressure sensitive adhesives and a thickness of 75 μm;
(16) A release film layer, of PET and a thickness of 185 μm.

The foregoing are merely some preferred embodiments of the present invention, and are not intended to limit the present invention, for those skilled in the art, various variations and changes can be made to the present invention. All modifications, equivalent replacements and improvements made within the spirit and essence of the present invention shall fall into the protection scope of the present invention.

1. A printable decal film having flashing points, comprising:
(1) A protective layer having a thickness of 2^{˜}188 μm;
(2) A coating layer having a thickness of 2^{˜}30 μm;
(3) A first substrate layer having a thickness of 20^{˜}500 μm;
(4) A first installation adhesive layer having a thickness of 5^{˜}100 μm;
(5) A printing layer having a thickness of 0.1^{˜}20 μm;
(6) A second substrate layer having a thickness of 2^{˜}188 μm;
(7) A second installation adhesive layer having a thickness of 20^{˜}100 μm; and
(8) A release film layer having a thickness of 12^{˜}188 μm.

2. The printable decal film having flashing points according to claim 1, wherein the protective layer is made from any of polyethylene terephthalate (PET), polyethylene (PE), oriented polypropylene (OPP).

3. The printable decal film having flashing points according to claim 1, wherein the coating layer comprises ethylene vinylacetate (EVA) having ultraviolet additives.

4. The printable decal film having flashing points according to claim 1, wherein the first substrate layer comprises any of thermoplastic polyurethane elastomer (TPU), polyvinyl chloride (PVC), thermoplastic polyurethane (TPH), PET or polypropylene (PP).

5. The printable decal film having flashing points according to claim 1, wherein the first installation adhesive layer is configured to attach the first substrate layer and the printing layer, and the first installation adhesive layer comprises an acrylate pressure sensitive adhesive layer having glitter powder.

6. The printable decal film having flashing points according to claim 1, wherein the printing layer comprises a colored layer or a pattern layer formed by inkjet printing by an inkjet printer.

7. The printable decal film having flashing points according to claim 1, wherein the second substrate layer comprises any of TPU, TPH, PET or PVC.

8. The printable decal film having flashing points according to claim 1, wherein the second installation adhesive layer is configured to attach the second substrate layer and the release film layer, and the second installation adhesive layer comprises an acrylate pressure sensitive adhesive layer.

9. The printable decal film having flashing points according to claim 1, wherein the release film layer comprises any of PET, PE or OPP.

10. The printable decal film having flashing points according to claim 9, wherein the release film layer comprises PET patterned release film.
